(19) United States
(12) Patent Application Publication
(10) Pub. No.: US 2013/0148513 A1
(43) Pub. Date: Jun. 13, 2013

(54) CREATING PACKET TRAFFIC CLUSTERING MODELS FOR PROFILING PACKET FLOWS

(71) Applicants: Geza SZABO, Kecskemet (HU); Gergely PONGRÁCZ, Gyor (HU); Zoltán TURÁNYI, Szentendre (HU)

(72) Inventors: Geza SZABO, Kecskemet (HU); Gergely PONGRÁCZ, Gyor (HU); Zoltán TURÁNYI, Szentendre (HU)

(73) Assignee: Telefonaktiebolaget LM, Stockholm (SE)

(21) Appl. No.: 13/315,037

(22) Filed: Dec. 8, 2011

(51) Int. Cl. H04L 12/26

(52) U.S. Cl. 370/252

(57) ABSTRACT

Packet traffic profiling models are created based on packet headers of a packet flow at a first model aggregation level to obtain first flow information describing packet-oriented parameters of the flow. A machine learning algorithm (MLA) creates a first model based on the first information, determines if the first model achieves a first confidence level, and if not, defines multiple flow slices in the packet flow. Flow slices at a second higher model aggregation level are processed to obtain second flow information describing flow slice-oriented parameters of the packet flow, and an MLA creates a second model based on the second information to determine if the second model achieves a second confidence level. If so, the process completes; if not, further processing continues at a next level. One of the models is selected for profiling packet traffic flows.

### RELATED APPLICATION

This application is related to U.S. patent application entitled, “Creating and using multiple packet traffic profiling models to profile packet flows,” Ser. No. 13/098,944, filed on May 2, 2011, and to U.S. patent application entitled, “Creating and using multiple packet traffic profiling models to profile packet flows,” Ser. No. 13/277,735, filed on Oct. 25, 2011, the contents of which are incorporated herein by reference.

### TECHNICAL FIELD

The technology relates to packet traffic profiling and creating models to perform such profiling.

### BACKGROUND

Efficient allocation of network resources, such as available network bandwidth, has become critical as enterprises increase reliance on distributed computing environments and wide area computer networks to accomplish critical tasks. Transport Control Protocol (TCP)/Internet Protocol (IP) protocol suite, which implements the world-wide data communications network environment called the Internet and is employed in many local area networks, omits any explicit supervisory function over the rate of data transport over the various devices that comprise the network. While there are certain perceived advantages, this characteristic has the consequence of juxtaposing very high-speed packets and very low-speed packets in potential conflict and produces certain inefficiencies. Certain loading conditions degrade performance of networked applications and can even cause instabilities which could lead to overloads that could stop data transfer temporarily.

Bandwidth management in TCP/IP networks to allocate available bandwidth from a single logical link to network flows is accomplished by a combination of TCP end systems and routers which queue packets and discard packets when some congestion threshold is exceeded. The discarded and therefore unacknowledged packet serves as a feedback mechanism to the TCP transmitter. Routers support various queuing options to provide for some level of bandwidth management including some partitioning and prioritizing of separate traffic classes. However, configuring these queuing options with any precision or without side effects is in fact very difficult, and in some cases, not possible.

Bandwidth management devices allow for explicit data rate control for flows associated with a particular traffic classification. For example, bandwidth management devices allow network administrators to specify policies operative to control and/or prioritize the bandwidth allocated to individual data flows according to traffic classifications. In addition, certain bandwidth management devices, as well as certain routers, allow network administrators to specify aggregate bandwidth utilization controls to divide available bandwidth into partitions to ensure a minimum bandwidth and/or cap bandwidth as to a particular class of traffic. After identification of a traffic type corresponding to a data flow, a bandwidth management device associates and subsequently applies bandwidth utilization controls (e.g., a policy or partition) to the data flow corresponding to the identified traffic classification or type.

More generally, in-depth understanding of a packet traffic flow's profile is a challenging task but nevertheless is a requirement for many Internet Service Providers (ISP). Deep Packet Inspection (DPI) may be used to perform such profiling to allow ISPs to apply different charging policies, perform traffic shaping, and offer different quality of service (QoS) guarantees to selected users or applications. However, DPI has a number of disadvantages including being a slow procedure, resource consuming, and unable to recognize types of traffic in which there is no signature set. Many critical network services may rely on the inspection of packet payload content, but there can be use cases when only looking at the structured information found in packet headers is feasible.

Traffic classification systems may include a training phase and a testing phase during which traffic is actually classified based on the information acquired in the training phase. FIG. 1 is diagram of a training operation to create multiple packet traffic flow models. The input of the training phase includes known packet traffic flows, and the output includes multiple packet traffic flow models. Packet traffic flow descriptors like average payload size, etc. (described in more detail below) are determined from the known packet traffic flows and used to generate clusters which are used to create the multiple packet traffic flow models. The models are stored for later use to profile unknown packet traffic flows.

FIG. 2 is diagram of one example way to profile or classify packet traffic flows using multiple packet traffic flow models created in FIG. 1. Unknown packet traffic flows are received and processed to determine multiple flow descriptors (in a similar way as in the training phase) with a particular accuracy and confidence level. The multiple packet traffic flow models created in the training phase are loaded and tested on the input data, and the one of them is selected to profile a particular one of the unknown traffic flows.

Unfortunately, in existing packet header-based traffic classification systems, the effects of network environment changes and the characteristic features of specific communications protocols are not identified and then considered together. But because each change and characteristic feature affects one or more of the other changes and characteristic features, the failure to consider them together along with respective interdependencies results in reduced accuracy when testing traffic a different network than was used the training phase was using.

Known packet header-based traffic classification methods provide information about a traffic flow only after the entire traffic flow is fully processed. But the inventors recognized that such full processing may not be necessary to satisfactorily develop (e.g., with a desired level of confidence) traffic classification models and/or classify traffic using such models. If such full processing is not necessary, resources and time are wasted. Another shortcoming identified by the inventors is inflexibility in the processing. Entire traffic flows are either processed to collect information at a packet level or at an entire traffic flow level but known packet header-based traffic classification methods do not propagate the information determined the packet level to the entire traffic flow level. Nor is analysis at intermediate levels available.

What is needed therefore is a traffic analysis approach that is more flexible, that uses resources more efficiently, that provides varying levels of model aggregation for traffic processing, and that provides the results of one or more lower model aggregation levels to a higher model aggregation processing level to take advantage of flow information obtained on the one or more lower model aggregation levels.

### SUMMARY

A computer creates packet traffic profiling models based on processing packet headers of a packet traffic flow at a first model aggregation level to obtain first packet traffic flow information describing packet-oriented parameters of the packet traffic flow. Non-limiting examples of first packet flow information include one or more of: packet inter-arrival time, packet size, and packet direction. The computer uses a machine learning algorithm to create a first traffic profiling model based on the first packet traffic flow information, determines if the first traffic profiling model achieves a first confidence level, and if not, defines multiple flow slices in the packet traffic flow, each flow slice including multiple packets. Multiple flow slices at a second higher model aggregation level are processed to obtain second packet traffic flow information describing flow slice-oriented parameters of the packet traffic flow. Non-limiting examples of second packet traffic flow information include one or more of: a number of transmitted packets in a slice, a sum of bytes transmitted in a slice, a distribution of packet inter-arrival times, and a distribution of packet sizes.

A machine learning algorithm is performed by the computer to create a second traffic profiling model based on some of the second packet traffic flow information and the first traffic profiling model and to determine if the second traffic profiling model achieves a second confidence level. If not, then the computer processes that packet traffic flow at a third higher model aggregation level to obtain third packet traffic flow information. Non-limiting examples of third packet traffic flow information includes one or more of: a number of transmitted packets in a slice, a sum of bytes transmitted in a slice, a distribution of packet inter-arrival times, and a distribution of packet sizes. The computer creates a third traffic profiling model based on the third packet traffic flow information and the second traffic profiling model.

One of the first, second, or third traffic profiling models is ultimately selected for profiling packet traffic flows. The traffic profiling model of the lowest associated model aggregation level may be selected if that traffic profiling model achieves a predetermined confidence level without having to perform steps related to higher model aggregation level. In one example embodiment, the selected traffic model is stored in memory, and the selection is based on which of the first, second, or third traffic models has a highest confidence level.

In one example implementation, the third model aggregation level and the third packet traffic flow information relate to the entire packet traffic flow. In another example implementation, the third model aggregation level and the third packet traffic flow information relate to user information associated with the traffic flow. In still another example implementation, the third model aggregation level and the third packet traffic flow information relate to physical site information associated with a source of the traffic flow.

The technology is scalable. For example, if the third traffic profiling model does not achieve a third confidence level, then the computer can process the packet traffic flow at a fourth model aggregation level higher than the third model aggregation level to obtain fourth packet traffic flow information and create a fourth traffic profiling model based on the fourth packet traffic flow information and the third traffic profiling model.

Another example of scalability is where multiple flow slices are processed at multiple slice aggregation levels to obtain different second packet traffic flow information of the packet traffic flow for different slice aggregation levels.

According to one example embodiment, the first, second, or third packet information includes one or more statistical descriptors.

Various non-limiting example techniques may be used to identify boundaries for the slices including using protocol flags contained in some of the packet headers, changes in bit rate, or a predetermined number of packets or bytes. In one example implementation, the slices have equal time periods.

Another aspect relates to determining the packet traffic flow information. One example to determine the packet traffic flow information from packet headers associated with a same user. Another example is to determine the packet traffic flow information from packet headers associated with a same site.

The first, second, or third packet traffic flow information may also be associated with a location within the packet traffic flow.

Non-limiting example machine learning algorithms include one or more of the following techniques: Support Vector Machine (SVM), logistic regression, naive Bayes, naive Bayes simple, logit boost, random forest, multilayer perception, J48, and Bayes net or expectation maximization, K-Means, cobweb hierarchic clustering, shared neighbor clustering, and constrained clustering.

The technology may be implemented in or connected to, for example, one or more of the following: a radio base station, a Serving GPRS Support Node (SGSN), Gateway GPRS Support Node (GGSN), Broadband Remote Access Server (BRAS), or Digital Subscriber Line Access Multiplexer (DSLAM).

### BRIEF DESCRIPTION OF THE DRAWINGS

FIG. 1 is diagram of an example training operation to create multiple packet traffic flow models;

FIG. 2 is diagram of an example for packet traffic flow profiling using multiple packet traffic flow models created in FIG. 1;

FIG. 3 is a non-limiting, example of multiple packet traffic flows with example features, labels, classifications, and clusterings;

FIGS. 4A and 4B provide example illustrations of clustering and classification;

FIG. 5 is a non-limiting flowchart illustrating example procedures for creating multiple packet traffic flow models;

FIG. 6 is a non-limiting, example diagram of multiple model aggregation level processing in accordance with FIG. 5;

FIG. 7 is a non-limiting, example of apparatus for training and profiling multiple packet traffic flows; and

FIG. 8 is a non-limiting, example of a communications system illustrating various nodes in which the traffic profiling model generation may be employed.

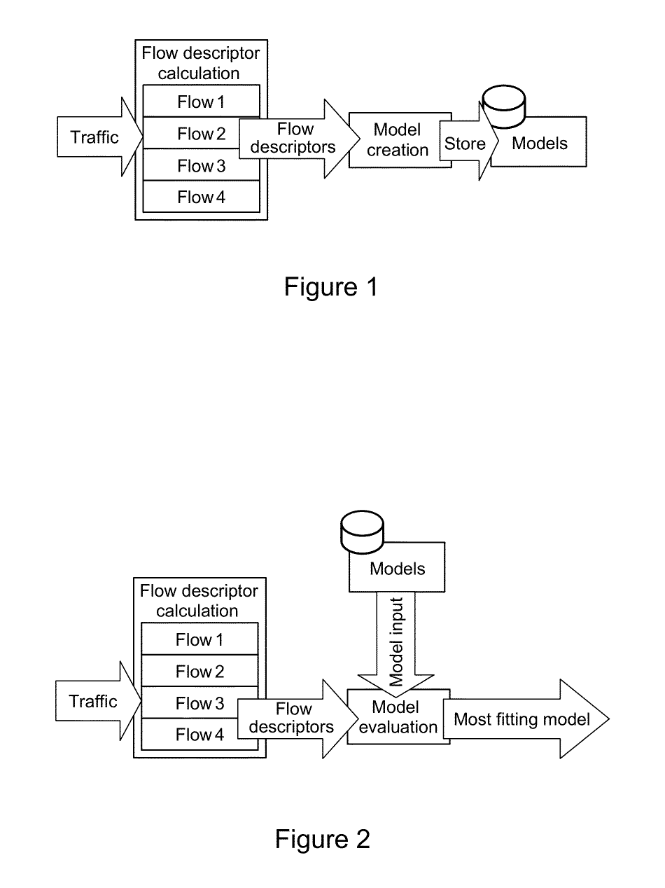

### DETAILED DESCRIPTION

The following description sets forth specific details, such as particular embodiments for purposes of explanation and not limitation. But it will be appreciated by one skilled in the art that other embodiments may be employed apart from these specific details. In some instances, detailed descriptions of well known methods, interfaces, circuits, and devices are omitted so as not obscure the description with unnecessary detail. Individual blocks may are shown in the figures corresponding to various nodes. Those skilled in the art will appreciate that the functions of those blocks may be implemented using individual hardware circuits, using software programs and data in conjunction with a suitably programmed digital microprocessor or general purpose computer, and/or using applications specific integrated circuitry (ASIC), and/or using one or more digital signal processors (DSPs). Nodes that communicate using the air interface also have suitable radio communications circuitry. The software program instructions and data may be stored on non-transitory, computer-readable storage medium, and when the instructions are executed by a computer or other suitable processor control, the computer or processor performs the functions.

Thus, for example, it will be appreciated by those skilled in the art that diagrams herein can represent conceptual views of illustrative circuitry or other functional units. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various illustrated elements may be provided through the use of hardware such as circuit hardware and/or hardware capable of executing software in the form of coded instructions stored on computer-readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

The technology described in this case may be applied to any communications system and/or network. A network device, e.g., a hub, switch, router, and/or a variety of combinations of such devices implementing a LAN or WAN, interconnects two other end nodes such as a client device and a server. The network device may include a traffic monitoring or testing module connected to a part of a communications path between the client device and the server to monitor one or more packet traffic flows. The network device may also include a training module for generating multiple packet traffic flow models used by the traffic monitoring module. Alternatively, the training module may be provided in a separate node from the network device, and the multiple packet traffic flow models are in that case provided to the traffic monitoring/testing module. In one example embodiment, the training module and the traffic monitoring/testing module each employ a combination of hardware and software, such as a central processing unit, memory, a system bus, an operating system and one or more software modules implementing the functionality described herein. The functionality of traffic monitoring/testing device can be integrated into a variety of network devices that classify network traffic, such as firewalls, gateways, proxies, packet capture devices, network traffic monitoring and/or bandwidth management devices, that are typically located at strategic points in computer networks.

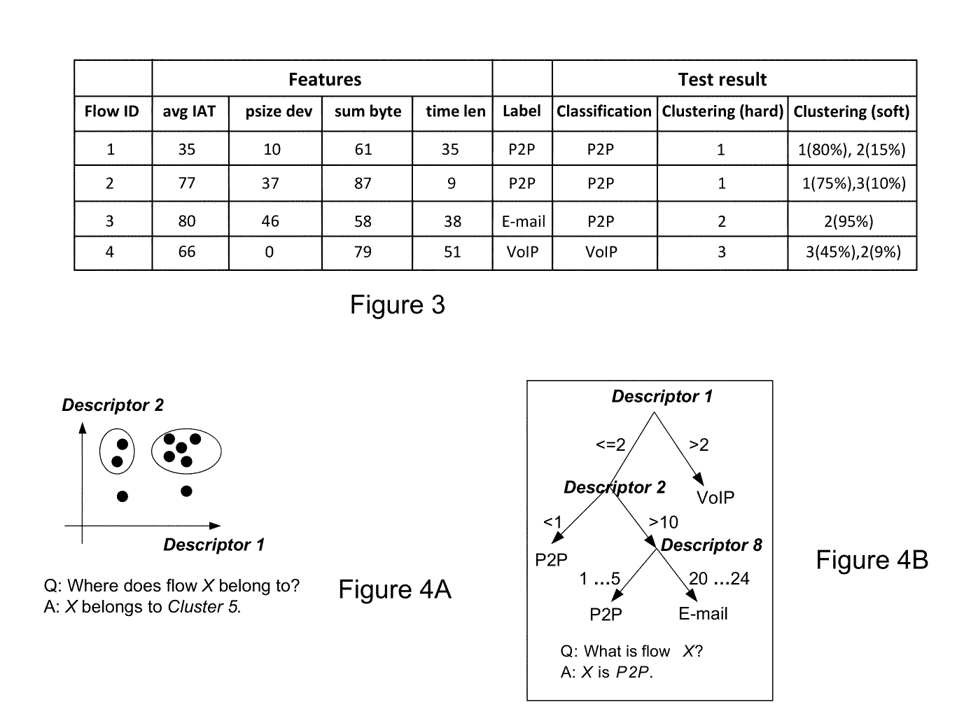

The table in FIG. 3 is a non-limiting, example of multiple packet traffic flows with example features, labels, classifications, and clusterings. Each of the four example flows has a flow identifier (ID), assigned features, and a label. Creating packet traffic flow models involves processing known packet traffic flows to associate them with (1) multiple traffic flow descriptors or “features” describing physical parameters of the known packet traffic flow and (2) one or more traffic flow “label” describing a type of packet traffic flow. Non-limiting example traffic flow features include one or more of: average packet inter-arrival time for a packet traffic flow, packet size deviation in a packet traffic flow, sum of bytes in a flow, time duration of a packet traffic flow, TCP flags set in a packet traffic flow, packet direction in a packet traffic flow, a number of packet direction changes, a number of transported packets for a packet traffic flow until a first packet direction change, or a statistically-filtered time series related to a packet traffic flow. Non-limiting example types of packet traffic flows include one of: a point-to-point traffic flow type, an e-mail traffic flow type, a voice over internet protocol (VoIP) traffic flow type. The test results for the traffic profiling of these flows is a traffic flow type classification (e.g., point-to-point (P2P), email, and voice over IP (VoIP)), a hard clustering result (e.g., 1, 2, or 3 with each number corresponding to a specific cluster), and a soft clustering result where the result is associated with a confidence value, (e.g., a certainty percentage). The test results show that flows 1, 2, and 4 are profiled correctly because the label for the flow matches its classification. On the other hand, the label for flow 3, email, differs from its classification of P2P.

FIG. 4A provides an example illustration of clustering which is unsupervised learning. The circled areas represent clusters of points where traffic flow descriptors 1 and 2 intersect. One cluster includes two points and the other five points. FIG. 4B provides an example illustration of classification which is supervised learning where features and labels are considered. The classification process is carried out using a decision tree in which several decisions are made on the descriptors (features and labels) of the flow. At the end of the decision tree process, the traffic flow is identified/classified.

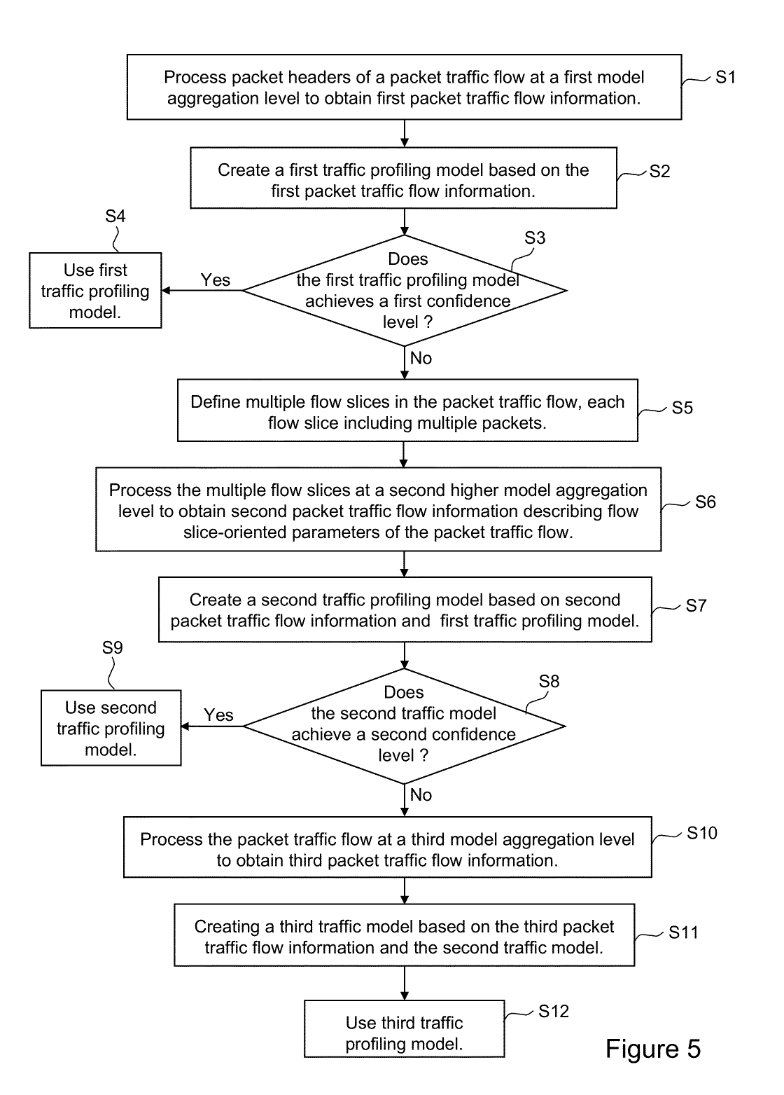

FIG. 5 is a non-limiting flowchart illustrating example procedures implemented by a computer for creating multiple packet traffic flow models. The computer processes packet headers of a packet traffic flow at an individual packet model aggregation level to obtain first packet traffic flow information describing packet-oriented parameters of the packet traffic flow (step S1). The methodology can be applied to one or multiple user packet traffic flows. In the case of multiple user packet traffic flows, those flows may be associated with different physical sites.

Collecting the first packet traffic flow information on a packet level means that the information is limited to individual packet information such as packet inter-arrival time, packet size, direction of the packet, and/or one or more statistical descriptors. Still, because many packets can be sampled, a high quality distribution for these descriptors may be achieved.

A first traffic profiling model is created based on the first packet traffic flow information (step S2). In an example, limiting embodiment, one or more machine learning algorithms may be used to assist in creating the traffic profiling models. However, other techniques that are not machine learning-based may be used to create models. Different types of machine learning algorithms. Non-limiting examples of computer-implemented unsupervised learning methods include: expectation maximization (EM), K-Means, cobweb hierarchic clustering, shared neighbor clustering, and constrained clustering. Non-limiting examples of computer-implemented unsupervised learning methods include: expectation maximization (EM), K-Means, cobweb hierarchic clustering, shared neighbor clustering, and constrained clustering.

Next, a determination is made (step S3) if the first traffic profiling model achieves a first confidence level. If so, that first traffic profiling model may be satisfactory for subsequent use as a traffic profiling model (step S4), and thus, model creation processing may cease to avoid wasting unnecessary resources. If not, the computer defines multiple flow slices in the packet traffic flow, each flow slice including multiple packets (step S5). The computer then processes the multiple flow slices at a “slice” aggregation level to obtain second packet traffic flow information describing flow slice-oriented parameters of the packet traffic flow (step S6). For example, the second packet information may include one or more of: a number of transmitted packets in a slice, a sum of bytes transmitted in a slice, a distribution of packet inter-arrival times, a distribution of packet sizes, and one or more statistical descriptors. The slice level aggregation permits temporal changes in the flow during its lifetime to be detected and modeled. For example, inactive periods in a flow which would otherwise distort the packet traffic flow information at the entire flow level can be accounted for.

The boundaries for the slices may be determined in any suitable fashion. One non-limiting example uses protocol flags contained in some of the packet headers to mark the slice beginning and end. Other examples may be based on changes in bit rate, a predetermined number of packets or bytes, or predetermined time periods, e.g., equal time periods.

A machine learning algorithm implemented by the computer may be used to create a second traffic profiling model based on some of the second packet traffic flow information and the first traffic profiling model (step S7). If the second traffic profiling model achieves a second confidence level, then the second traffic profiling model may be satisfactory for subsequent use as a traffic profiling model (step S9), and model creation processing may cease to avoid wasting unnecessary resources. If not, then processing by the computer the packet traffic flow at a flow model aggregation level of a higher model aggregation than the second model aggregation level to obtain third packet traffic flow information (step S10). A third traffic profiling model may be created, e.g., using a machine learning algorithm, based on the third packet traffic flow information and the second traffic profiling model (step S11).

In one non-limiting example embodiment, the third model aggregation level and the third packet traffic flow information relate to the entire packet traffic flow. In that case, the third packet information may include one or more of: a number of transmitted packets in a slice, a sum of bytes transmitted in a slice, a distribution of packet inter-arrival times, a distribution of packet sizes, and/or one or more statistical descriptors, e.g., a certain derivative, such as minimum, maximum, average, standard deviation, median, quantiles, etc. More complex statistical descriptors can also be used, e.g., moments, autocorrelation, spectrum, H-parameter, recurrence plot-statistics, etc. One example entire traffic flow definition is the collection of packets traveling on the same “5-tuple,” i.e., same source address, source port, destination address, destination port, and protocol, in one direction. The traffic flow starts when the first packet is sent and ends when there is no further packet within a specific timeout period (e.g., 120 secs).

In another non-limiting example embodiment, the third model aggregation level and the third packet traffic flow information relate to user information associated with the traffic flow. In yet another non-limiting example embodiment, the third model aggregation level and the third packet traffic flow information relate to physical site information associated with a source of the traffic flow.

Using multiple model aggregation levels adds flexibility and efficiency. By providing results of one level to a higher model aggregation level, traffic profiling model creation is performed more effectively and efficiently with increasing degrees of confidence associated with created models.

Ultimately, one of the first, second, or third traffic profiling models is selected for use in profiling packet traffic flows, e.g., to determine the flow's traffic type. Preferably, the traffic profiling model of the lowest associated model aggregation level that achieves a predetermined confidence level is selected so as to avoid having to perform processing at a higher model aggregation level. Other selection methods may be used. For example, the traffic profiling model selection may be based which traffic profiling model has a highest confidence level. The selected traffic profiling model is stored in memory.

While the first, second, or third traffic profiling models may be any suitable traffic profiling model, in one example embodiment, they are traffic clustering models. However, the first, second, or third traffic profiling models need not all be of the same type.

Additional processing model aggregation may be employed. For example, if the third traffic profiling model does not achieve a third confidence level, the packet traffic flow may be processed at a model aggregation level higher than the next-highest model aggregation level to obtain further packet traffic flow information. A further model is created based on the further packet traffic flow information and the third traffic profiling model. Alternatively or in addition, multiple flow slices may be processed at multiple slice aggregation levels to obtain different second packet traffic flow information of the packet traffic flow for different slice aggregation levels. Flow slices can be constructed on several slice aggregation levels. E.g., based on 10, 100, and/or 1000 packets. By providing different characteristics on the different slice aggregation levels, the technology is scalable.

In one example embodiment, the packet traffic flow information is determined from packet headers associated with a same user. User level aggregation of the traffic also makes it possible to identify human behavior patterns. For example, performing a port scan traffic flow-by-traffic flow may not reveal much information for creating a traffic profiling model, but it may reveal information regarding the original purpose or motive of the user in sending the traffic flow. In another example embodiment, the packet traffic flow information is determined from packet headers associated with a same physical site. Site level aggregation makes it possible to analyze the traffic of particular sites including for example a server farm, company site, or customer home.

In both the above example cases, it is possible that information on the common traffic flow level model aggregation can not be deduced. In that situation, at least user or site level information may be possible to obtain about the traffic. In addition, when considering the traffic of a user/site, it is difficult to determine a characteristic behavior on an individual flow level. But on a user/site level, a characteristic behavior can be determined and used to profile all the traffic going to that specific user/site.

Traffic flow characteristics can change over time. For example, the same traffic flow can be used for multiple purposes during its lifetime. In this case, misleading conclusions may be drawn if one views only packet traffic flow information for the entire traffic flow without accounting for packet traffic flow information on the slice level. Slice level packet traffic flow information is typically not burdensome to monitor or maintain in memory because that information is per slice as opposed to a relatively large amount of packet traffic flow information that needs to be stored for an entire traffic flow. In a preferred example embodiment, the packet traffic flow information collected at the packet level and one or more slice levels are tagged or otherwise associated with information about where in the traffic flow the particular packet or slice is located, which facilitates use by higher model aggregation level processing.

The technology can provide traffic flow information for each model aggregation level as soon as enough information is gained at that model aggregation level to achieve a required confidence level. For example, if just five packets provide traffic flow classification with a high level of confidence then further processing is not needed. But if the confidence level is too low, then the results of one or more lower model aggregation levels are passed to a higher model aggregation level together with the unreliable traffic profiling model information obtained from the information available at the current level. The higher model aggregation level can then make use of this unreliable, but still potentially indicative model information.

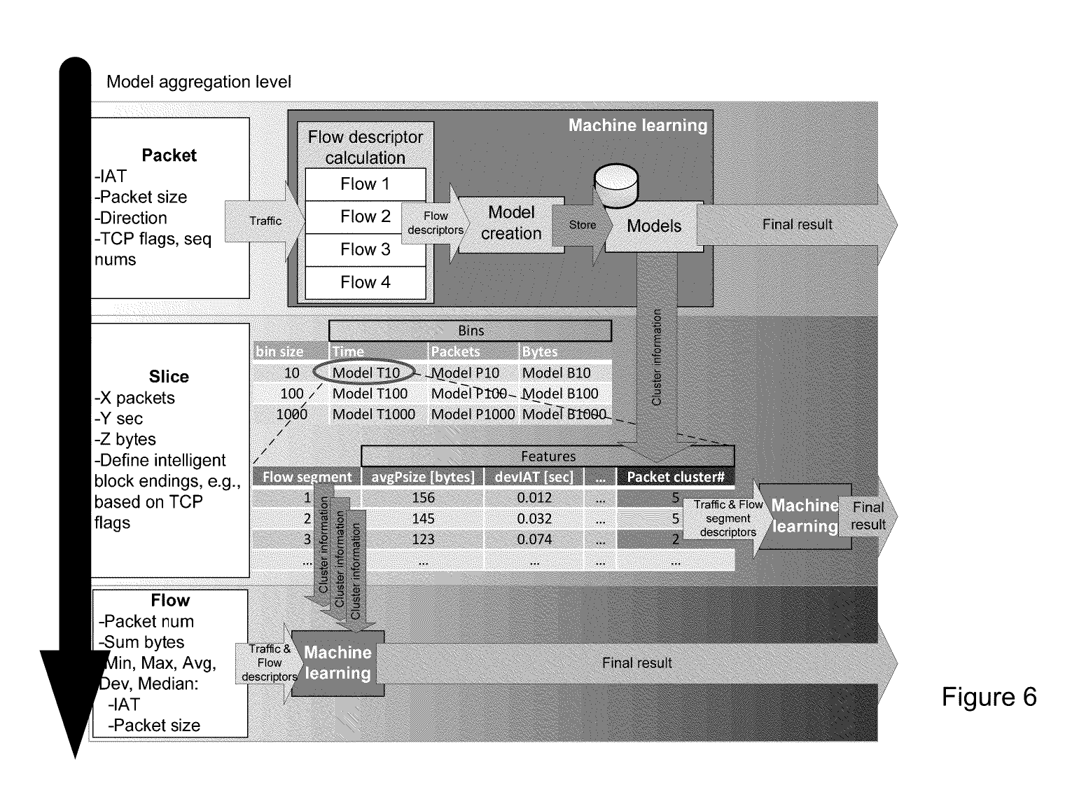

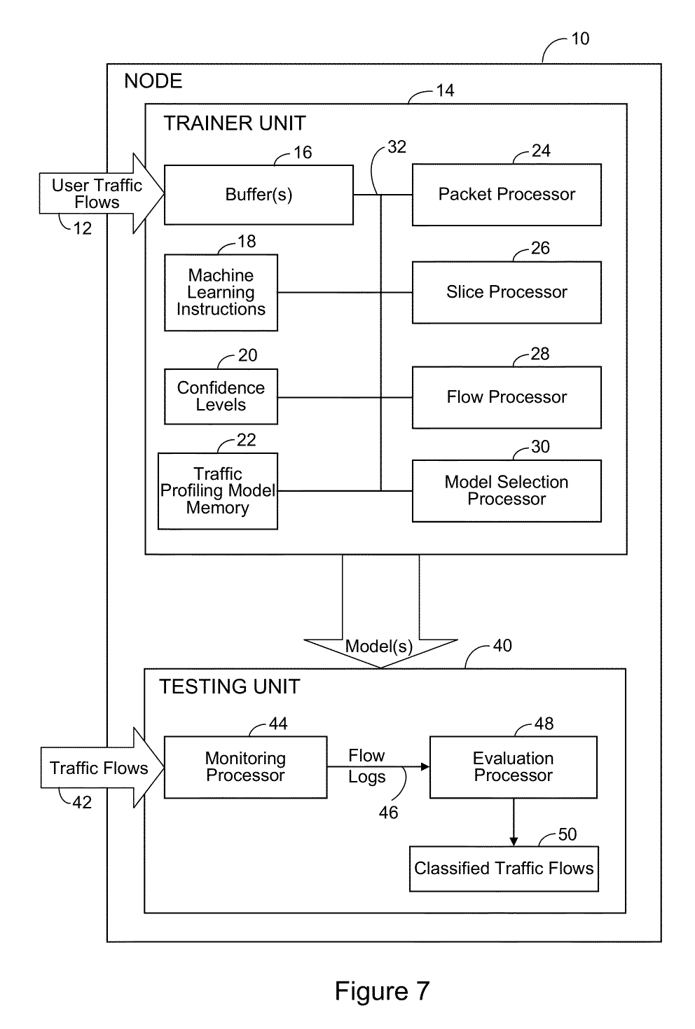

FIG. 6 illustrates a non-limiting, example of multiple model aggregation level processing. At a first packet model aggregation level, the headers of traffic flow packets are analyzed to determine example packet flow information including inter-arrival time (TAT), packet size, packet direction (uplink, downlink), TCP flags in case of TCP packets, and packet sequence number. In this case, this analysis is performed on four know packet traffic flows 1-4. If the analysis performed, e.g., for 10 packets, 10*(3+F) features are stored, where F is the number of TCP flags. The obtained packet flow information for all four flows (“flow descriptors” in the figure) are used to create a first packet-based traffic profiling model and calculate an associated confidence level for that model. The model is stored in a model memory, and the model and confidence level are available for possible subsequent use in profiling/classifying unknown traffic flows.

At the next higher model aggregation level, the flows 1-4 are each processed at a slice level, where each slice boundary may be defined by number of packets, amount of time, number of bytes, TCP flags, etc. The flow slice (labeled as “segment” in figure) traffic flow information (average packet size, deviation of inter-arrival time, etc.) is used along with the packet-based model information from the lower model aggregation level (the models in this example are cluster-based models) to create a slice level traffic profiling model along with an associated confidence level. If 10 second long slices are used as an example, the first 10 seconds of the flow is the first slice. Statistical features may be calculated for each slice and used as features to a machine learning algorithm. Statistics of the next 10 second slice of the flow are analyzed, and so on. A predetermined number of slices may be analyzed, e.g., 10, and the statistical features for that many slices maintained. The cumulative statistical features may be maintained in a circular fashion. For example, if the number of the slices to be analyzed is more than 10, then a statistical feature of the 11^{th} slice is calculated and stored together with the 1^{st} slice, the 12^{th} slice together with the 2^{nd} slice, etc.

At the next higher model aggregation level, the flows 1-4 are each processed at an entire flow level. Entire traffic flow information (packet number, sum of bytes, minimum, maximum, average, deviation, and/or median inter arrival time, and/or minimum, maximum, average, deviation, and/or median packet size) is used along with the slice-based model information from the next lower model aggregation level to create a flow level traffic profiling model along with an associated confidence level.

In the traffic profiling model example, propagating the result of one model aggregation level to a next higher level may, in one example embodiment, be done using cluster numbers. Cluster numbers as features or belonging to a specific cluster can be considered as a normalization or an aggregation result of several features. In other words, clustered some traffic flows have one or more features that are similar. Propagating label information may cause problems when a next higher model aggregation level is needed because information on a current model aggregation level may not be sufficiently precise, i.e., it does not achieve an appropriate confidence level to decide on the final label, so the selected label may be a wrong label. This way the final label may be selected according to the features on the current model aggregation level plus the aggregated features from the previous model aggregation levels as opposed to selected labels.

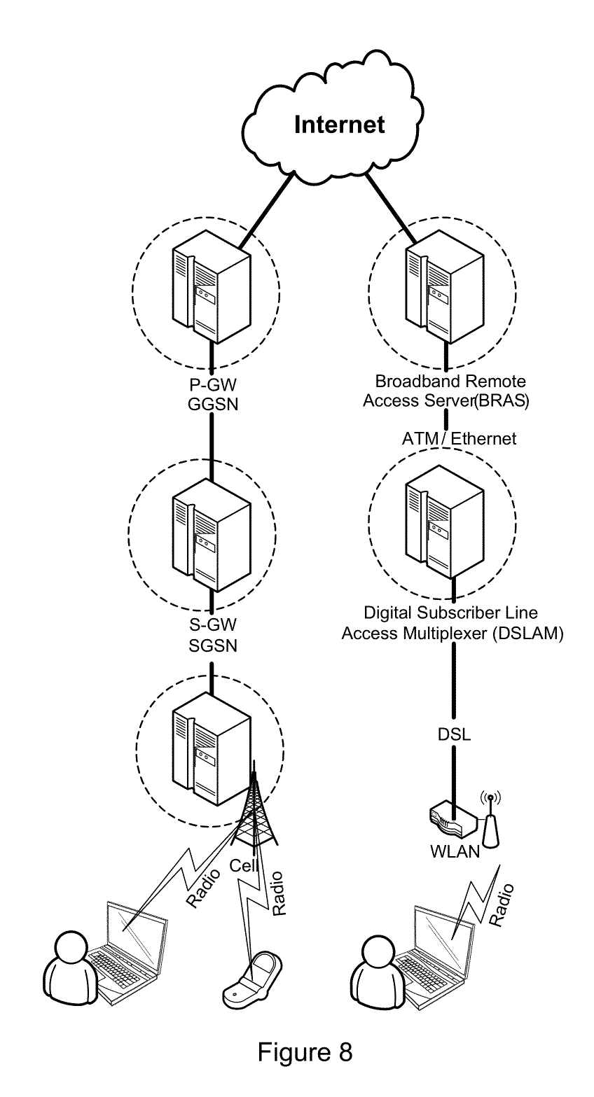

FIG. 8 is a non-limiting, example function block diagram of an example node 10 that includes a trainer unit 12 and profiling or testing unit 40 for respectively performing packet traffic flow model creation and packet traffic flow profiling functions based on those created models. Known user packet traffic flows 12 are provided to/received at a trainer unit 14 and stored in one or more buffers 16. The buffer(s) 16 are coupled via suitable interconnect circuitry 32, to a memory 18 storing machine learning algorithm instructions, a memory 20 storing one or more predetermined model confidence levels for one or more model aggregation levels, a memory 22 for storing traffic profiling models, a packet processor 24 for performing the packet processing described above, a slice processor for performing the slice level processing described above, a flow processor for performing the flow level processing described above, and a model selection processor 30 for selecting one or more suitable models for use the testing unit 40. Although individual memories are shown, a single memory, fewer memories, or more memories may be used. Although individual processors are shown, a single processor, fewer processors, or more processors may be used.

A testing or profiling unit or module 40 receives unknown traffic flows 42 at a monitoring device 44 which determines features for each traffic flow and generates a corresponding flow log for each flow. The profiling unit 40 may be in the same node or a different node as the trainer unit 10. An evaluation processor 48 receives the flow logs 46 from the monitoring device 44, a confidence factor for each flow log, and the clustering and classification models 30 and 34. All of this information is processed by the evaluation unit. The evaluation processor 48 may, in a preferred example embodiment, employ an expert system to perform the model evaluation. An example expert system may be based on the well known Dempster-Shafer (D-S) decision making. The outputs of the evaluation processor 48 are flow types classifying each of the unknown packet traffic flows 42.

FIG. 9 is a non-limiting, example of a communications system illustrating various example nodes in which the model generation and/or traffic profiling may be employed. The illustrated example network nodes that can support one or both of the training and profiling units may observe the packet traffic of several users and thus are circled. They include a radio base station, a Serving GPRS Support Node (SGSN), Gateway GPRS Support Node (GGSN), Broadband Remote Access Server (BRAS), or Digital Subscriber Line Access Multiplexer (DSLAM). Although also possible as an implementation node, the WLAN access point is a very low aggregation point and thus is not circled as are the other nodes. Of course, the technology may be used in other suitable network nodes.

The technology advantageously only requires processing packet header information, and thus, can also deal with encrypted traffic since payload encryption does not affect the traffic characteristics. Traffic profiling models may be created at multiple different model aggregation levels, and if a model at a lower model aggregation level satisfies the confidence or accuracy requirements for a particular application, the model creation process may be halted without incurring additional processing and resource costs. Another advantage of the technology is its ability to learn properties of traffic flows at different levels. As a result, the technology can determine the behavior of traffic flows for small, medium, and long time scales. By changing the level(s) of confidence, the technology can be adapted to suit a particular application or task. For example, by decreasing a confidence level for a file sharing application and increasing a confidence level for a VoIP traffic application, the system can be “tuned” to higher performance for a higher volume, file sharing traffic application with a relatively low traffic profiling accuracy requirement, and tuned to a lower performance for a smaller volume of revenue-generating VoIP traffic that must be identified with higher accuracy.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology described, for it to be encompassed by the present claims. No claim is intended to invoke paragraph 6 of 35 USC §112 unless the words “means for” or “step for” are used. Furthermore, no embodiment, feature, component, or step in this specification is intended to be dedicated to the public regardless of whether the embodiment, feature, component, or step is recited in the claims.

1. A method performed by a computer for creating packet traffic profiling models, comprising:
processing by the computer packet headers of a packet traffic flow at a first model aggregation level to obtain first packet traffic flow information describing packet-oriented parameters of the packet traffic flow;
using a machine learning algorithm implemented by the computer to create a first traffic profiling model based on the first packet traffic flow information;
determining if the first traffic profiling model achieves a first confidence level, and if not,
defining multiple flow slices in the packet traffic flow, each flow slice including multiple packets;
then processing by the computer the multiple flow slices at a second higher model aggregation level to obtain second packet traffic flow information describing flow slice-oriented parameters of the packet traffic flow and using a machine learning algorithm implemented by the computer to create a second traffic profiling model based on some of the second packet traffic flow information and the first traffic profiling model;
determining if the second traffic profiling model achieves a second confidence level, and if not,
then processing by the computer the packet traffic flow at a third model aggregation level higher than the second model aggregation level to obtain third packet traffic flow information and creating a third traffic profiling model based on the third packet traffic flow information and the second traffic profiling model; and
selecting one of the first, second, or third traffic profiling models for use in profiling packet traffic flows.

2. The method in claim 1, wherein the selecting includes selecting the traffic profiling model of the lowest associated model aggregation level if that traffic profiling model achieves a predetermined confidence level without having to perform steps related to higher model aggregation level.

3. The method in claim 1 applied to multiple user packet traffic flows associated with different physical sites.

4. The method in claim 1, wherein the third model aggregation level and the third packet traffic flow information relate to the entire packet traffic flow.

5. The method in claim 1, wherein the third model aggregation level and the third packet traffic flow information relate to user information associated with the traffic flow.

6. The method in claim 1, wherein the third model aggregation level and the third packet traffic flow information relate to physical site information associated with a source of the traffic flow.

7. The method in claim 1, further comprising determining if the third traffic profiling model achieves a third confidence level, and if not, then processing by the computer the packet traffic flow at a further model aggregation level higher than the third model aggregation level to obtain fourth packet traffic flow information and creating a further model based on the fourth packet traffic flow information and the third traffic profiling model.

8. The method in claim 1, further comprising processing the multiple flow slices at multiple slice aggregation levels to obtain different second packet traffic flow information of the packet traffic flow for different slice aggregation levels.

9. The method in claim 1, wherein the first, second, or third traffic profiling models are traffic clustering models.

10. The method in claim 1, wherein the first packet information includes one or more of: packet inter-arrival time, packet size, and packet direction.

11. The method in claim 10, wherein the second packet information includes one or more of: a number of transmitted packets in a slice, a sum of bytes transmitted in a slice, a distribution of packet inter-arrival times, and a distribution of packet sizes.

12. The method in claim 11, wherein the third packet information includes one or more of: a number of transmitted packets in a slice, a sum of bytes transmitted in a slice, a distribution of packet inter-arrival times, and a distribution of packet sizes.

13. The method in claim 1, wherein the first, second, or third packet information includes one or more statistical descriptors.

14. The method in claim 1, further comprising identifying boundaries for the slices are determined using protocol flags contained in some of the packet headers.

15. The method in claim 1, further comprising identifying boundaries for the slices based on changes in bit rate.

16. The method in claim 1, further comprising identifying boundaries for the slices based on a predetermined number of packets or bytes.

17. The method in claim 1, further comprising defining the slices to have equal time periods.

18. The method in claim 1, wherein the packet traffic flow information is determined from packet headers associated with a same user.

19. The method in claim 1, wherein the packet traffic flow information is determined from packet headers associated with a same site.

20. The method in claim 1, further comprising associating the first, second, or third packet traffic flow information with a location within the packet traffic flow.

21. The method in claim 1, wherein machine learning algorithm includes one or more of the following techniques: Support Vector Machine (SVM), logistic regression, naive Bayes, naive Bayes simple, logit boost, random forest, multilayer perception, J48, and Bayes net or expectation maximization, K-Means, cobweb hierarchic clustering, shared neighbor clustering, and constrained clustering.

22. The method in claim 1, wherein the method is implemented in or connected to one or more of the following: a radio base station, a Serving GPRS Support Node (SGSN), Gateway GPRS Support Node (GGSN), Broadband Remote Access Server (BRAS), or Digital Subscriber Line Access Multiplexer (DSLAM).

23. An apparatus for creating packet traffic profiling models, comprising:
a receiving port for receiving a packet traffic flow;
processing circuitry configured to:
process packet headers of the packet traffic flow at a first model aggregation level to obtain first packet traffic flow information describing packet-oriented parameters of the packet traffic flow and to determine a first traffic profiling model based on the first packet traffic flow information;
define multiple flow slices in the packet traffic flow, each flow slice including multiple packets,
process the multiple flow slices at a second higher model aggregation level to obtain second packet traffic flow information describing flow slice-oriented parameters of the packet traffic flow, and
determine a second traffic profiling model based on some of the second packet traffic flow information and the first traffic profiling model;
process the packet traffic flow at a third model aggregation level higher than the second model aggregation level to obtain third packet traffic flow information, and
determine a third traffic profiling model based on the third packet traffic flow information and the second traffic profiling model; and
configured to select one of the first, second, or third traffic profiling models for use in profiling packet traffic flows.

24. The apparatus in claim 23, wherein the selection includes selecting the traffic profiling model of the lowest associated model aggregation level if that traffic profiling model achieves a predetermined confidence level without having to perform steps related to higher model aggregation level.

25. The apparatus in claim 23, wherein the processing circuitry is configured to process packet headers of multiple user packet traffic flows associated with different physical sites.

26. The apparatus in claim 23, wherein the third model aggregation level and the third packet traffic flow information relate to the entire packet traffic flow.

27. The apparatus in claim 23, wherein the third model aggregation level and the third packet traffic flow information relate to user information associated with the traffic flow.

28. The apparatus in claim 23, wherein the third model aggregation level and the third packet traffic flow information relate to physical site information associated with a source of the traffic flow.

29. The apparatus in claim 23, further comprising determining if the third traffic profiling model achieves a third confidence level, and if not, then the processing circuitry is configured to process the packet traffic flow at a fourth model aggregation level higher than the third model aggregation level to obtain fourth packet traffic flow information and create a fourth model based on the fourth packet traffic flow information and the third traffic profiling model.

30. The apparatus in claim 23, wherein the processing circuitry is configured to process the multiple flow slices at multiple slice aggregation levels to obtain different second packet traffic flow information of the packet traffic flow for different slice aggregation levels.

31. The apparatus in claim 23, wherein the first packet information includes one or more of: packet inter-arrival time, packet size, and packet direction.

32. The apparatus in claim 31, wherein the second packet information includes one or more of: a number of transmitted packets in a slice, a sum of bytes transmitted in a slice, a distribution of packet inter-arrival times, and a distribution of packet sizes.

33. The apparatus in claim 32, wherein the third packet information includes one or more of: a number of transmitted packets in a slice, a sum of bytes transmitted in a slice, a distribution of packet inter-arrival times, and a distribution of packet sizes.

34. The apparatus in claim 23, wherein the first, second, or third packet traffic flow information is associated with a location within the packet traffic flow.

35. The apparatus in claim 23, wherein machine learning algorithm includes one or more of the following techniques: Support Vector Machine (SVM), logistic regression, naive Bayes, naive Bayes simple, logit boost, random forest, multilayer perception, J48, and Bayes net or expectation maximization, K-Means, cobweb hierarchic clustering, shared neighbor clustering, and constrained clustering.

36. The apparatus in claim 23 implemented in one or more of the following: a radio base station, a Serving GPRS Support Node (SGSN), a Gateway GPRS Support Node (GGSN), a Broadband Remote Access Server (BRAS), or a Digital Subscriber Line Access Multiplexer (DSLAM).

37. The apparatus in claim 23, wherein the processing circuitry is configured to determine one of the traffic profiling models by executing a machine learning algorithm.

38. The apparatus in claim 23, wherein the processing circuitry is configured to process the multiple flow slices at the second higher model aggregation level only if the first traffic profiling model fails to achieve a first confidence level, and to process the entire traffic flow at the third higher model aggregation level only if the second traffic profiling model fails to achieve a second confidence level.
